(19) United States
(12) Patent Application Publication
(10) Pub. No.: US 2005/0138090 A1
(43) Pub. Date: Jun. 23, 2005

(54) Method and apparatus for performing a backup of data stored in multiple source medium

(76) Inventors: Oliver Augenstein, Dettenhausen (DE); Joerg Erdmenger, Waldenbuch (DE)

Correspondence Address: DILLION & YUDELL, LLP, 8911 N CAPITAL OF TEXAS HWY, SUITE 2110, AUSTIN, TX, 78759, US

(21) Appl. No.: 11/007,601

(22) Filed: Dec. 8, 2004

(30) Foreign Application Priority Data
Dec. 17, 2003 (EP) 03104745.9

(51) Int. Cl. G06F 17/30

(52) U.S. Cl. 707/204

(57) ABSTRACT

A method and apparatus for performing a backup of data stored in multiple source medium are disclosed. A first backup file is initially generated on a backup medium. Then, data blocks of a first and second source files are written onto the first backup file. In response to the receipt of a last data block from one of the source files, the last data block is written to the first backup file and the first backup file is closed such that the first backup file contains all the data from one of the source files and a subset of data from the other source file. Subsequently, a second backup file is generated on the backup medium. After all the remaining data from the other source file have been written to the second backup file, the second backup file is closed such that the second backup file contains the remaining data from the other source file.

### BACKGROUND OF THE INVENTION

1. Technical Field

The present invention relates to data backup in general, and, in particular, to a method and apparatus for performing data backup. Still more particularly, the present invention relates to a method and apparatus for performing a backup of data that are distributed over several groups of files.

2. Description of Related Art

There are many well-known data backup methods for backing up data in files that are distributed across several groups. Most of the data backup methods allow data in files of different groups to be handled in parallel in order to improve backup performance. Such data backup methodologies are particularly suitable for files that are stored on different source medium.

During a data backup operation, typically one file is opened on each source media for parallel reading, and the data of a set of files are merged into one data stream that are written to one backup media. Then, a next file on each source media is opened to start over the procedure of parallel reading, merging into one data stream and writing data to the backup media, until all files that needed to be backed up are completely written to the backup media. As a result, the data from different source medium are commingled in one backup media in such a way that a restore of single source file is nearly impossible. It may take roughly the same time to restore one single source file as it takes to restore all source files.

In addition, if files have different sizes, it is very likely that one of the files has been read completely while the other files are still in process. Then, the source media on which the smaller file is located will be idle even though there may be other files on that source media still waiting for backup. Thus, as the backup operation progresses, more and more source medium will be become idle, which leads to a decrease of the amount of data read per second. In order to lessen such effect, files of similar size can be combined in one set of files for parallel handling. Nevertheless, the backup performance normally decreases during the backup of files with different sizes.

Consequently, it would be desirable to provide an improved method and apparatus for performing a backup of data that are distributed over several groups of files.

### SUMMARY OF THE INVENTION

In accordance with a preferred embodiment of the present invention, a first backup file is initially generated on a backup medium. Then, data blocks of a first and second source files are written onto the first backup file. In response to the receipt of a last data block from one of the source files, the last data block is written to the first backup file and the first backup file is closed such that the first backup file contains all the data from one of the source files and a subset of data from the other source file. Subsequently, a second backup file is generated on the backup medium. After all the remaining data from the other source file have been written to the second backup file, the second backup file is closed such that the second backup file contains the remaining data from the other source file.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIGS. 1a and 1b illustrate the generation of backup files according to the proposed backup solution;

FIG. 2 illustrates the backup of source files, in accordance with a preferred embodiment of the present invention;

FIG. 3 illustrates the restore of source files, in accordance with a preferred embodiment of the present invention;

FIG. 4 is a high-level logic flow diagram of a method for implementing the prerequisites of the present invention;

FIG. 5 is a high-level logic flow diagram of a method for implementing a backup assembling of the present invention; and

FIG. 6 is a high-level logic flow diagram of a method for implementing a restore assembling of the present invention.

### DETAILED DESCRIPTION OF A PREFERRED EMBODIMENT

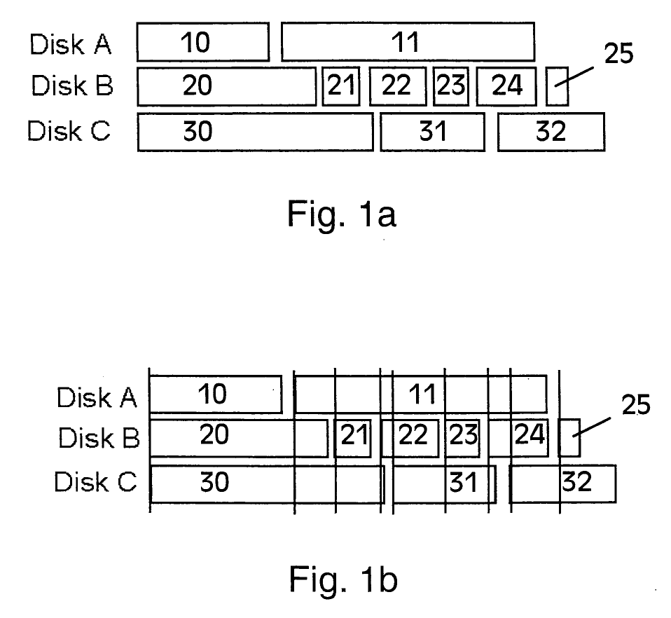

Referring now to the drawings and in particular to FIG. 1a, there is illustrated a group of source files represented in corresponding boxes. The size of a box corresponds to the size of a source file. The source files are distributed over three disks, namely, disk A, disk B and disk C. All source files located on one disk form a group for the purpose of performing a backup operation. As shown in FIG. 1a, files 10-11 of disk A form a first group, files 20-25 of disk B form a second group, and files 30-32 of disk C form a third group.

In order to perform a backup of files 10-11, 20-25 and 30-32, the data from one source file of each group is read simultaneously starting with files 10, 20 and 30. The reading is done in data blocks, and the data blocks are multiplexed to form one single sequence of data blocks. Then, the sequence of data blocks is written to a sequence of backup files created on a backup medium. After the last data block of a source file has been read, another source file of the same group is opened immediately for reading until all source files have been completely written to the backup medium.

According to a preferred embodiment of the present invention, a new backup session is started each time one source file of a group is completely written to the backup medium and another source file of the same group is opened for reading. Each data block read from a source file is labeled with meta information in order to associate the data block with the source file and to identify the last data block of the source file. With such, a backup file in process can be closed as soon as the last data block of any open source file has been written to the backup file, and a second backup file can be created as soon as a new source file from any group is opened for backup.

FIG. 1b shows the diagram of FIG. 1a with vertical lines, each vertical line indicating the staring point of a new backup session as well as the ending point of the previous backup session. The time of each backup session corresponds to the width between two vertical lines. Each backup session is stored in a separate backup file. The diagram of FIG. 1b shows that each backup file includes data of a source file from a disk from which the last source file was completely read and data of the rest of the source files still in progress. Thus, only files 10, 21, 23 and 25 are separately written onto one single backup file in their entirety. In contrast, files 11, 20, 22, 24 and 30-32 are distributed over several backup files with each backup file having data fractions of one source file from each group.

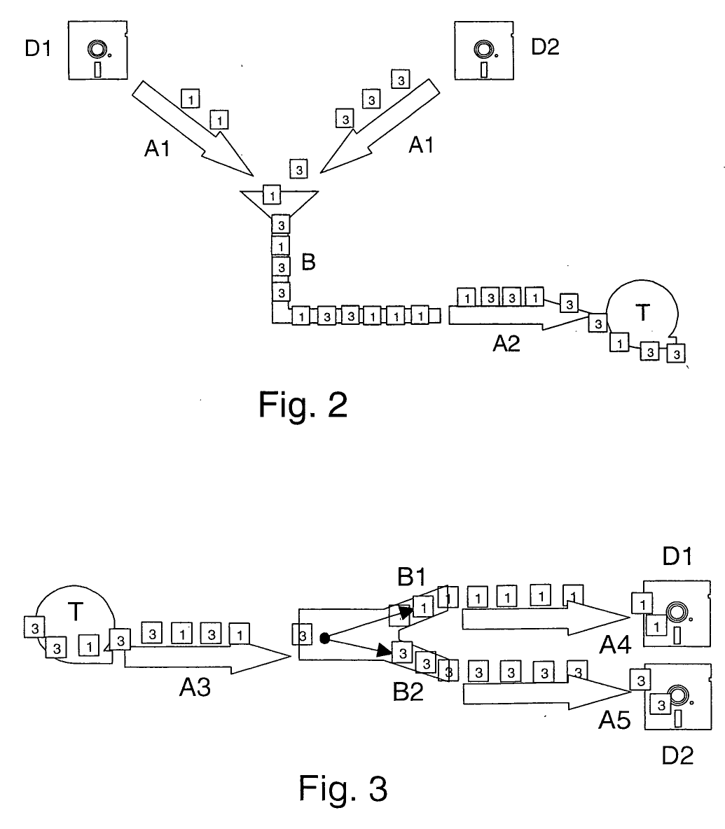

FIG. 2 illustrates the backup solution of the present invention by ways of an example of backing up two source files with the file names file_1 and file_2 being located on a first disk D1, and two source files with the file names file_3 and file_4 being located on a second disk D2. For the present example, a tape T is used as a backup medium.

The backup procedure starts with creating a new backup file on tape T having an artificial name, say file_A. Then, file_1 on disk D1 and file₁₃3 on disk D2 are opened for reading. Data from file_1 and file_3 are read in parallel to improve throughput. The reading is performed in data blocks, and each data block is labeled with an index 1 or 3 in order to associate the data block with the corresponding source file. Arrows A1 indicate the resulting read streams of data blocks. The data blocks read from disk D1 and from disk D2 are multiplexed via a multiplexer. Each data block is sent to a buffer B as soon as it is available at the multiplexer. All read streams post their corresponding data blocks to buffer B. Data blocks are then extracted from buffer B to form one output stream indicated by arrow A2. Subsequently, the data blocks are written to the backup file file_A on tape T.

As soon as the first data block of an opened source file—file_1, file_2, file_3 or file_4—is handled, a lookup table is updated. The lookup table maps the names of the source files located on the disks D1 and D2 to the names of the corresponding backup files. In the present example, the first entries of the lookup table are: “file_1 starts in file_A” and “file_3 starts in file₁₃A.” As soon as the last data block of one of the source files opened for reading, say file_1, has been completely written to tape T, the backup file in process, i.e., file₁₃A, can be closed and a new backup file can be created, if necessary. The last data block of a source file is identified by corresponding meta information provided by reading the source file from the corresponding disk.

For example, as soon as a source file, such as file_1, has been completely read from one disk, i.e. disk D1, a new source file, such as file_2, from the same disk D1 is opened for reading, if there is still a source file left in disk D1 to be backed up. In addition, a new backup file having an artificial name, say file_B, is created on tape T, and a timely ordered list with the names of the backup files is updated. Then, the backup operation continues, as described above, until all source files to be backed up have been completely written to tape T.

In the present example, the data of the entire file_1 are stored in file_A along with a fraction of the data from file_3. Thus, the data of file_3 are distributed across at least two backup files, namely file_A and file_B.

FIG. 3 illustrates the restoration of source files after a backup operation as described in FIG. 2. The backup medium is tape T, and the source files to be restored are written to two different disks, namely, disk D1 and disk D2. After a request to restore files, such as file_1, file_2, file_3 and file_4, from tape T has been made, the artificial file names of the first backup file containing data of these source files are identified in the lookup table. For the present example, the result from the lookup table can be: file_A for file_1 and file_3;. file_B for file_2; and file_C for file_4. Then, file_A is read from tape T in one read stream of data blocks, indicated by arrow A3. These data blocks still contain the meta information that were placed during the backup operation. The meta information allow each data block to relate to a corresponding source file. The meta information also identifies the last data block of a source file.

The read stream is fed to a demultiplexer having a number of buffers, each corresponds to the number of disks in which the data will be stored. In the present example, there are two different buffers B1 and B2 in the demultiplexor. Buffer B1 is related to disk D1 while buffer B2 is related to disk D2. As soon as a data block reaches the demultiplexer, its meta information is read. Depending on the index read, which relates the data block to a source file, the data block is put into one of buffers B1 or B2. Thus, each of buffer B1 and B2 contains either data from file_1 or file_3. The data is extracted from buffers B1 and B2 in two parallel restore streams that are indicated by arrows A4 and A5, respectively. The restore stream A4 containing only data blocks of file_1 is written to disk D1 while the restore stream A5 containing only data blocks of file_3 is written to disk D2.

As soon as the data of file_A has been completely transferred, the restoration of one of the source files, such as file_1, is finished. Such is determined by reading the meta information that includes a “last block” flag. Then, file_1 is closed on disk D1, and file_B is opened on tape T to continue with reading data from tape T until all source files to be restored are completely transferred to the corresponding disk.

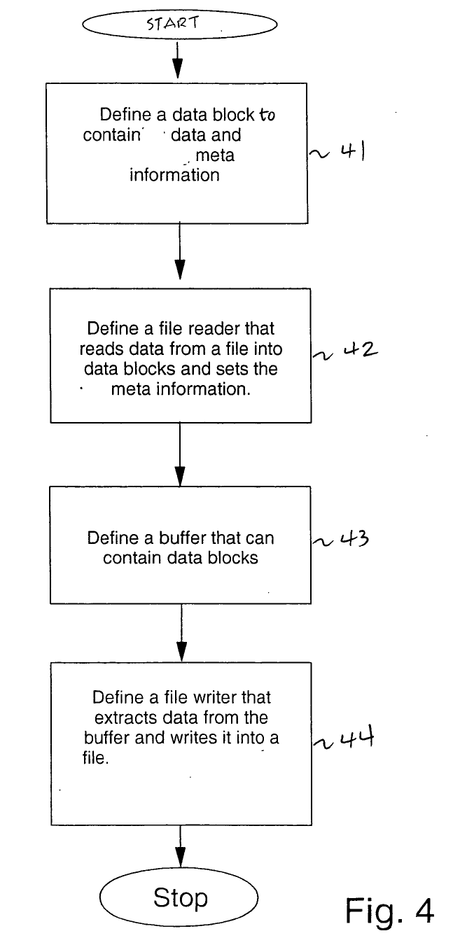

FIG. 4 shows the steps necessary for implementing the prerequisites of the present invention. First, a data block is defined to contain data and the meta information, as shown in block 41. The meta information may include information such as the file name of the data block and whether or not the data block is the last data block of a source file. Then, a file reader capable of reading and converting data from a source file into data blocks is defined, and the meta information are set, as depicted in block 42. Next, a buffer capable of holding the data blocks is defined, as shown in block 43. Finally, a file writer capable of extracting data blocks (along with their meta information) from a buffer and writing the data blocks into a file is defined, as depicted in block 44. The file writer closes the file each time it has written a “last block” meta information.

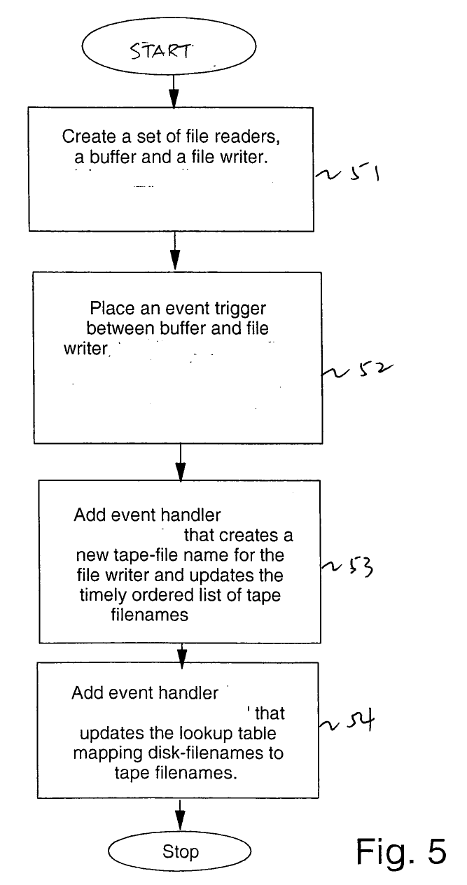

Referring now to FIG. 5, there is illustrated a high-level logic flow diagram of a method for performing data backup, in accordance with a preferred embodiment of the present invention. First, a set of file readers is created together with a buffer for a multiplexer and a file writer, as shown in block 51. The set of file readers, the buffer, the multiplexer and the file writer have to be linked so that the file readers can read data blocks from the source files of the different groups and feed the data blocks to the multiplexer where the data blocks are posted into the buffer. The file writer has to be linked to the buffer in order to extract the data blocks from the buffer, and writes the data block to a backup medium.

Then, an event trigger is placed between the buffer and the file writer, as depicted in block 52. The event trigger can be triggered by events such as “last block” received and first time seeing “file name.” Next, a first event handler is added, as shown in block 53. The first event handler creates a new backup file name for the file writer and updates a timely ordered list of the backup files. Finally, a second event handler is added, as depicted in block 54. The second event handler updates a lookup table that maps each source file name to the name of the first backup file containing data of the source file.

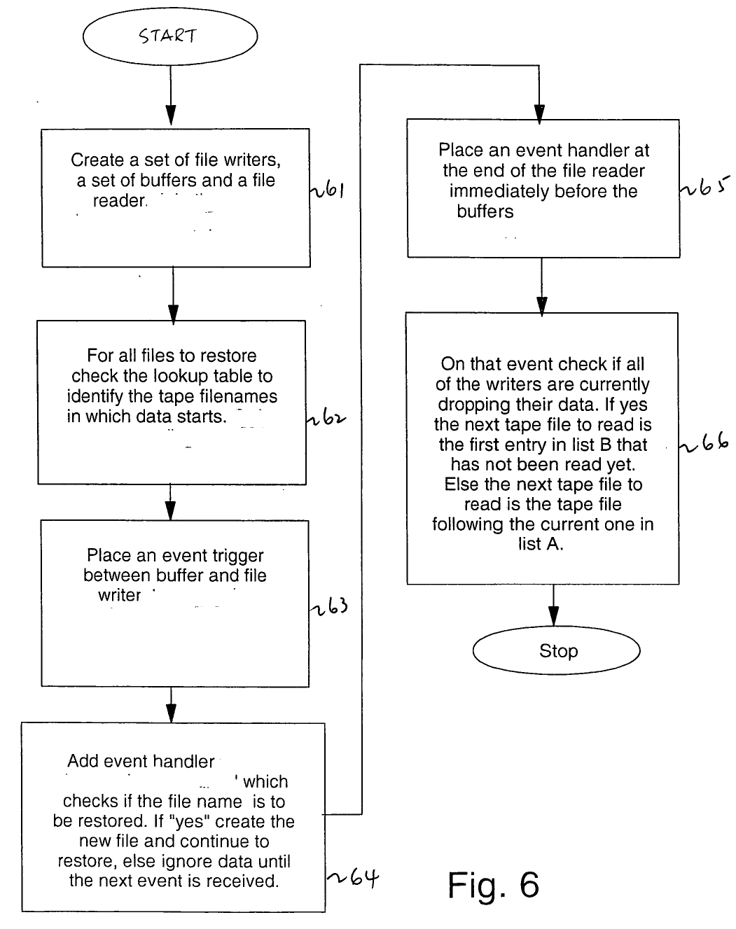

With reference now to FIG. 6, there is illustrated a high-level logic flow diagram of a method for performing data restoration, in accordance with a preferred embodiment of the present invention. First, a file reader is created together with a set of buffers for the demultiplexer and a set of file writers, as shown in block 60. The file reader, the buffers and the file writers have to be linked so that the file reader can read data blocks from the backup medium and feed the data blocks to the demultiplexer where the data blocks are distributed to the buffers. One file writer has to be linked to each of the buffers to extract the data blocks and write the data blocks to a corresponding source file. In case of a request to restore selected source files, the first backup files containing data of the source files are identified by checking the lookup table, as depicted in block 62. The identified backup files are ordered according to time in a separate processing list.

A first event trigger is placed between each of the buffers and the file writer to trigger the events of first time seeing “file name,” as shown in block 63. Then, a first event handler is added for first time seeing “file name” events, as depicted in block 64. The first event handler checks, if the corresponding source file is to be restored. If “yes,” a new file is created on the corresponding source medium and the restoration process continues. Otherwise, the corresponding data are ignored until the next event of first time seeing “file name” is received. A second event trigger is placed at the end of the file reader immediately before the buffers to trigger the events of “last block” received.

Then, a second event handler is added for “last block” received events, as shown in block 65. The second event handler checks, if all of the file writers are currently dropping their data, as depicted in block 66. If “yes,” the next backup file to read is the first entry in the processing list that has not been read yet. If there is at least one source file left for which restoring has already started but is not yet completed, the next backup file to read is that backup file following the backup file in process.

As has been described, the present invention provides a method and apparatus for performing a backup of data that are distributed over several groups of files.

Those skilled in the art will appreciate that the mechanisms of the present invention are capable of being distributed as a program product in a variety of forms, and that the present invention applies equally regardless of the particular type of signal bearing media utilized to actually carry out the distribution. Examples of signal bearing media include, without limitation, recordable type media such as floppy disks or CD ROMs and transmission type media such as analog or digital communications links.

While the invention has been particularly shown and described with reference to a preferred embodiment, it will be understood by those skilled in the art that various changes in form and detail may be made therein without departing from the spirit and scope of the invention.

1. A method for performing a backup of data stored in multiple source medium, said method comprising:
generating a first backup file on a backup medium;
writing data blocks of a first and second source files to said first backup file; and
in response to the receipt of a last data block from one of said source files:
writing said last data block to said first backup file;
closing said first backup file such that said first backup file contains all data from said one of said source files and a subset of data from the other one of said source files;
generating a second backup file on said backup medium; and
after writing the remaining data from the other one of said source files to said second backup file, closing said second backup file such that said second backup file contains the remaining data from the other one of said source files.

2. The method of claim 1, wherein said method further includes concurrently reading data blocks from said first source file on a first source medium and data blocks from said second source file on a second source medium.

3. The method of claim 1, wherein each of said data block is associated with meta information for relating the data block to one of said source files and to identify the last data block of a source file.

4. The method of claim 1, wherein said method further includes multiplexing said data blocks by posting each data block into a buffer.

5. The method of claim 4, wherein said method further includes extracting data blocks from said buffer in a single stream before said writing data blocks to said backup files.

6. The method of claim 1, wherein said method further includes updating a lookup table as soon as a first data block of one of said source files, wherein said lookup table maps a name of said one of said source files to a name of a first backup file containing data from said one of said source files.

7. A computer program product residing in a computer readable medium for performing a backup of data stored in multiple source medium, said computer program product comprising:
program code means for generating a first backup file on a backup medium;
program code means for writing data blocks of a first and second source files to said first backup file; and
in response to the receipt of a last data block from one of said source files:
program code means for writing said last data block to said first backup file;
program code means for closing said first backup file such that said first backup file contains all data from said one of said source files and a subset of data from the other one of said source files;
program code means for generating a second backup file on said backup medium; and
program code means for closing said first backup file, after the remaining data from the other one of said source files have been written to said second backup file, such that said second backup file contains the remaining data from the other one of said source files.

8. The computer program product of claim 7, wherein said computer program product further includes program code means for concurrently reading data blocks from said first source file on a first source medium and data blocks from said second source file on a second source medium.

9. The computer program product of claim 7, wherein each of said data block is associated with meta information for relating the data block to one of said source files and to identify the last data block of a source file.

10. The computer program product of claim 7, wherein said computer program product further includes program code means for multiplexing said data blocks by posting each data block into a buffer.

11. The computer program product of claim 10, wherein said computer program product further includes program code means for extracting data blocks from said buffer in a single stream before said writing data blocks to said backup files.

12. The computer program product of claim 7, wherein said computer program product further includes program code means for updating a lookup table as soon as a first data block of one of said source files, wherein said lookup table maps a name of said one of said source files to a name of a first backup file containing data from said one of said source files.

13. An apparatus for performing a backup of data stored in multiple source medium, said apparatus comprising:
means for generating a first backup file on a backup medium;
means for writing data blocks of a first and second source files to said first backup file; and
in response to the receipt of a last data block from one of said source files:
means for writing said last data block to said first backup file;
means for closing said first backup file such that said first backup file contains all data from said one of said source files and a subset of data from the other one of said source files;
means for generating a second backup file on said backup medium; and
means for closing said first backup file, after the remaining data from the other one of said source files have been written to said second backup file, such that said second backup file contains the remaining data from the other one of said source files.

14. The apparatus of claim 13, wherein said apparatus further includes means for concurrently reading data blocks from said first source file on a first source medium and data blocks from said second source file on a second source medium.

15. The apparatus of claim 13, wherein each of said data block is associated with meta information for relating the data block to one of said source files and to identify the last data block of a source file.

16. The apparatus of claim 13, wherein said apparatus further includes means for multiplexing said data blocks by posting each data block into a buffer.

17. The apparatus of claim 16, wherein said apparatus further includes means for extracting data blocks from said buffer in a single stream before said writing data blocks to said backup files.

18. The apparatus of claim 13, wherein said apparatus further includes means for updating a lookup table as soon as a first data block of one of said source files, wherein said lookup table maps a name of said one of said source files to a name of a first backup file containing data from said one of said source files.
